(19) United States
(12) Patent Application Publication
(10) Pub. No.: US 2016/0077751 A1
(43) Pub. Date: Mar. 17, 2016

(54) COALESCING MEMORY ACCESS REQUESTS

(71) Applicant: HEWLETT-PACKARD DEVELOPMENT COMPANY, L.P., Houston, TX (US)

(72) Inventor: Melvin K. Benedict, Magnolia, TX (US)

(21) Appl. No.: 14/787,673

(22) PCT Filed: Apr. 30, 2013
(86) PCT No.: PCT/US2013/038861

§ 371 Date: Oct. 28, 2015

(51) Int. Cl. G06F 3/06

(52) U.S. Cl. CPC G06F 3/0619; G06F 3/0622; G06F 3/0659; G06F 3/0673

(57) ABSTRACT

A computing system can include a processor and a memory. The computing system can also include a memory controller to interface between the processor and the memory. The memory controller coalesces requests to access a memory row to form a single request to access the memory row.

### CROSS-REFERENCE TO RELATED APPLICATION

This application is a United States National Stage Application of International Patent Application No. PCT/US2013/038861, filed on Apr. 30, 2013, the contents of which are incorporated by reference as if set forth in their entirety herein.

### BACKGROUND

Computing systems typically include a memory to store instructions to be executed by a processor and temporary storage for data. The memory can be dynamic random access memory (DRAM). DRAM includes modules or banks of DRAM circuits. A memory controller typically interfaces between the processor and the memory.

### BRIEF DESCRIPTION OF THE DRAWINGS

Certain examples are described in the following detailed description and in reference to the drawings, in which:

FIG. 1 is a block diagram of an example of a computing system;

FIG. 2 is a block diagram of an example of a memory system;

FIG. 3 is a process flow diagram of an example of a method of reordering a memory access request; and

FIG. 4 is a process flow diagram of an example of a method of reordering a memory access request.

### DETAILED DESCRIPTION OF SPECIFIC EMBODIMENTS

Memory can suffer from failures caused by fault mechanisms. Failures can be caused by a variety of fault mechanisms, including but not limited to repeated accesses to read or write data at a specific word-line. Repeated accesses to read or write data at a specific word-line can affect the contents of the storage elements associated with other word-lines (i.e., physical memory storage components) that are physically adjacent to the repeatedly accessed or activated word-line. Repeatedly accessing a word-line can cause discharge of adjacent word-lines.

In order to mitigate the effects of repeated accesses (i.e. “hammer” or “pass gate” fault mechanisms), memory controllers can track row address activity to enforce row access policies. However, tracking row address activity can add complexity to the memory controller.

Page open policy can decrease activation rates to the DRAM. Page open policy is a page (a block of memory addresses) management policy in which a page is stored in a buffer as an array. The page is contained in the buffer until access to a different page is requested. However, page open policy can increase the occurrence of row conflicts. A row conflict is a conflict in which access to a page other than the page stored in the buffer is requested. As a result of the row conflict, a delay occurs, during which the page is purged from the buffer and the requested page is stored in the buffer as an array. As a result of the latency caused by row conflicts, the efficiency of the DRAM memory is decreased.

Row conflicts can be addressed by reordering requests in a memory controller work flow when row conflicts are detected. To reorder requests, all of the row addresses being worked within the memory controller are tracked and a received request is compared to all requests in the work flow. This method can be complex. Additionally, reordering reads can increase latency and data returned from reordered write operations can be reordered before being returned to the processor.

By comparing an incoming request to access an address in a memory row of address spaces, requests to access the memory row can be coalesced to form a single request to access the memory row. As a result, activation of the memory row can be decreased. Because activation of the memory row is decreased, failures related to repeated activation are also decreased.

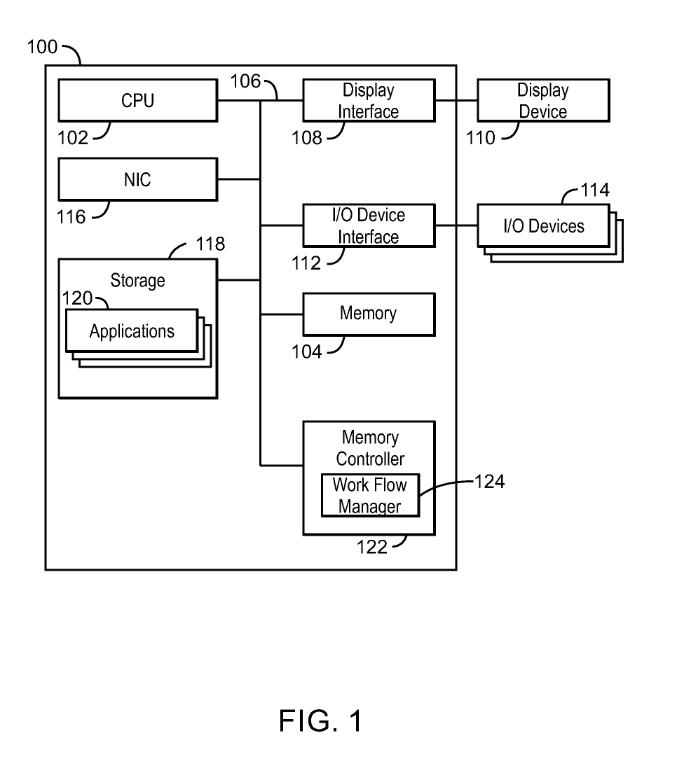

FIG. 1 is a block diagram of an example of a computing system.

The computing system 100 can be, for example, a desktop computer, a server, a laptop computer, a tablet computer, a personal digital assistant (PDA), or a cellular phone, such as a smartphone, among others. The computing system 100 can include a central processing unit (CPU) 102 to execute stored instructions, as well as a memory device 104 that stores instructions that are executable by the CPU 102. Additionally, the CPU 102 can be a single core processor, a multi-core processor, or any number of other configurations. Furthermore, the computing system 100 can include more than one CPU 102. For example, the computing system 100 can include a plurality of compute nodes, each compute node including a single or multiple processors.

The CPU 102 can be coupled to the memory device 104 by a bus 106. In an example, the memory device 104 can include dynamic random access memory (DRAM), such as DRAM including multiple modules or BANKs. The computing system 100 can also include multiple memories 104. For example, a memory 104 can be coupled to each CPU 102. In an example, the computing system 100 can include multiple memories 104, each memory coupled to a compute node, or each memory 104 accessible by all compute nodes, included in the computing system 100.

The CPU 102 can be linked through the bus 106 to a display interface 108 to connect the computing system 100 to a display device 110. The display device 110 can include a display screen that is a built-in component of the computing system 100. The display device 110 can also include a computer monitor, television, or projector, among others, that is externally connected to the computing system 100.

The CPU 102 can also be connected through the bus 106 to an input/output (I/O) device interface 112 to connect the computing system 100 to one or more I/O devices 114. The I/O devices 114 can include, for example, a keyboard and a pointing device, wherein the pointing device can include a touchpad or a touchscreen, among others. The I/O devices 114 can be built-in components of the computing system 100, or can be devices that are externally connected to the computing system 100.

A network interface card (NIC) 116 can connect the computing system 100 through the system bus 106 to a network (not depicted). The network (not depicted) can be a wide area network (WAN), local area network (LAN), or the Internet, among others. In an example, the computing system 100 can connect to a network via a wired connection or a wireless connection.

The computing system 100 also includes a storage device 118. The storage device 118 is a physical memory such as a hard drive, an optical drive, a thumbdrive, a secure digital (SD) card, a microSD card, an array of drives, or any combinations thereof, among others. The storage device 118 can also include remote storage drives. The storage device 118 includes any number of applications 120 that run on the computing system 100.

The computing system also includes a memory controller 122 for accessing memory 104. In an example, the computing system can include multiple memory controllers 122, each memory controller 122 associated with a memory 104. The memory controller 122 includes a work flow manager 124. Requests to access memory 104 are received in the memory controller 122. The memory row to which the request is requesting access is determined by the memory controller. The work flow manager 124 determines if a request to access the memory row is present in the work flow of the memory controller 122. If a request to access the memory row is present in the work flow, the work flow manager 124 coalesces (i.e., combines) the received request with the request in the work flow to form a single request to access the memory row.

For example, for a read operation, the memory controller can coalesce the request to memory by either rearranging the order of the requests or eliminating request if the request accesses the same cache as a previous request. The memory can respond to the requester in order of receipt of the read request. For a write request, multiple writes to a given memory location can be combined if they are different “dirty” bytes (a memory location to which a data write was interrupted) or coalesced into a single write with the combined copy of the write being the copy sent to memory.

It is to be understood the block diagram of FIG. 1 is not intended to indicate that the computing system 100 is to include all of the components shown in FIG. 1 in every case. Further, any number of additional components can be included within the computing system 100, depending on the details of the specific implementation.

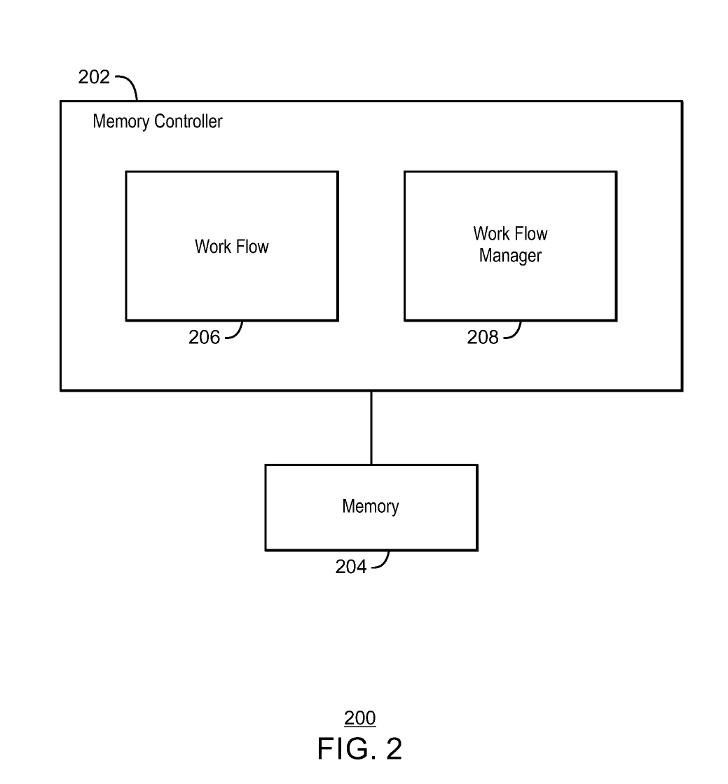

FIG. 2 is a block diagram of an example of a memory system 200. The memory system 200 includes a memory controller 202. The memory controller 202 interacts with, and controls access to, a memory 204. For example, the memory controller can interface between a processor, such as CPU 102, and the memory 204. In an example, the memory 204 can be dynamic random access memory (DRAM). For example, the memory 204 can include multiple modules or BANKs. Each module includes a plurality of memory addresses. The memory addresses are defined by their location in the memory modules, including row, column, page, etc. in which the address is located.

Requests to access the memory 204 are received in the memory controller 202. The request can be a read request (i.e., a request to read data stored in the memory 204) or a write request (i.e., a request to write data to the memory 204). The request can include information defining the location to be accessed in the memory 204. For example, the request can include row, column, and page information, among others. When the request is received in the memory controller 202, the location information is extracted.

The memory controller includes a work flow 206. The work flow 204 is a queue, or multiple queues, of memory requests to be processed. For example, work flow 206 can include an execution queue including requests scheduled to be processed. The work flow 206 can also include a queue of requests waiting to be scheduled in the execution queue. The position of each request in the queue of the work flow 206 can be determined in any suitable manner. For example, the position of each request can be assigned based on the positions of previously scheduled requests.

The memory controller 202 also includes a work flow manager 208. The work flow manager 208 analyzes the extracted location information to determine the row of the memory 204 to which the received request refers. The work flow manager 208 also determines if a request to access the row to which the received request refers is present in the work flow 206. If a request to access the same row is present in the work flow 206, the work flow manager 208 coalesces the received request with the request in the work flow 206 to form a single request to access the row.

When the coalesced request has been processed, data can be returned to the processor. The memory controller 202 can reorder the data before returning the data to the processor. For example, the memory controller 202 can reorder the data in order to comply with ordering rules of the computing system. Ordering rules are the programmatic order in which writes are to occur in a computing system. Multiple writes to a common location can be coalesced if there is not an intervening read request. Read requests can be coalesced if there is not intervening write request. The controller can track the read and write requests being processed and return the appropriate data in programmatic order. The data can be any type of data, such as requested date stored in the memory 204. For example, the data can be a notice of completion or a notice of a failure to complete a write of data to the memory 204.

If a request to access the same row is not present in the work flow 206, the work flow manager 208 can place the received request in the work flow 206. The placement of the received request in the work flow 206 can be determined in any suitable manner. For example, in a computing system including a plurality of requests processed in parallel, the received request can be placed in the work flow 206 such that a BANK conflict is not created. A BANK conflict is a conflict caused when a processor in a system processing memory access requests in parallel attempts to access a memory bank that is already the subject of a memory access.

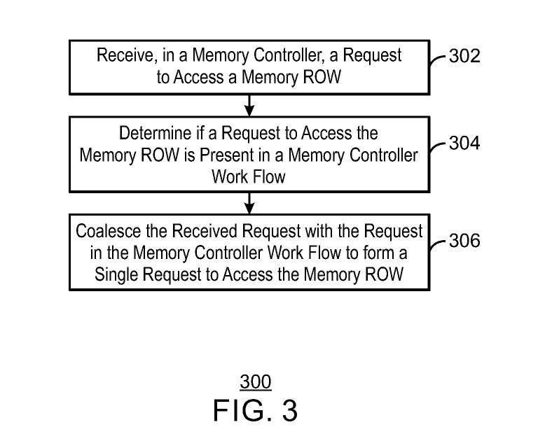

FIG. 3 is a process flow diagram of an example of a method 300 of reordering a memory access request. At block 302, a request to access a memory address can be received in a memory controller. The request can be a request to read data stored in the memory address or a request to write data to the memory address. In an example, the memory address can be a memory address in dynamic random access memory (DRAM). The request can include information describing the location of the memory address, such as row, column, and page information, among others.

At block 304, the memory controller can determine if a request to access the memory row is present in a memory controller work flow. Any suitable method of analyzing requests in the memory controller work flow can be used.

At block 308, the received request can be coalesced with the request in the memory controller work flow to form a single request to access the memory row. The requests in the memory controller work flow can be reordered to coalesce the requests. For example, the received request can be placed in the work flow with the request already in the work flow to facilitate coalescing the requests. In an example, a request in the memory controller work flow can include multiple coalesced requests. The received request can be coalesced with the previously coalesced requests to form a new coalesced request.

Data can be returned to the processor after the coalesced request is processed. The data can be data requested from the memory or the data can be a notice of completion or failure of a request to write data to the memory. The memory controller can reorder the data before returning the data to the processor. For example, the memory controller can reorder the data to comply with ordering rules of the computing system employing the method 300. In an example, the blocks of the method can be pipelined.

It is to be understood that the process flow diagram of FIG. 3 is not intended to indicate that the blocks of the method 300 are to be executed in any particular order, or that all of the blocks of the method 300 are to be included in every case. Further, any number of additional blocks not shown in FIG. 3 can be included within the method 300, depending on the details of the specific implementation.

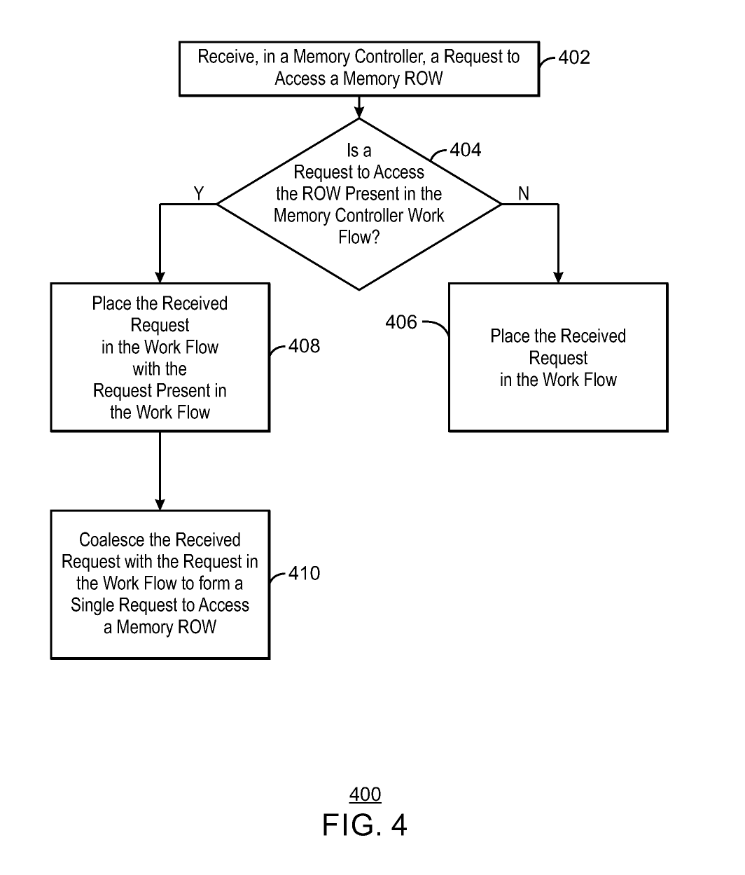

FIG. 4 is a process flow diagram of an example of a method 400 of reordering a memory access request. At block 402, a request to access a memory address can be received in a memory controller. The request can be a request to read data stored in the memory address or a request to write data to the memory address. A processor, such as CPU 102, can initiate the request. In an example, the memory address can be a memory address in dynamic random access memory (DRAM).

At block 404, the memory controller can determine if a request to access the row in the memory is present in the memory controller work flow. If a request to access the row is not present, at block 406 the memory controller can place the received request in the work flow. The received request can be placed in the work flow in any suitable manner, such as based on requests previously scheduled in the work flow. For example, the received request can be placed in the work flow in the work flow such that a BANK conflict is avoided.

If a request to access the row is present in the memory controller work flow, at block 408 the received request can be placed in the work flow with the request present in the work flow. At block 410, the received request can be coalesced with the request present in the work flow to form a single request to access a memory row. Requests present in the work flow can be reordered in order to coalesce the received request and the request to access the memory row present in the work flow.

Data can be returned to the processor after the coalesced request is processed. The data can be data requested from the memory or the data can be a notice of completion or failure of a request to write data to the memory. The memory controller can reorder the data before returning the data to the processor. For example, the memory controller can reorder the data to comply with ordering rules of the computing system employing the method 300. In an example, the blocks of the method can be pipelined.

It is to be understood that the process flow diagram of FIG. 4 is not intended to indicate that the blocks of the method 400 are to be executed in any particular order, or that all of the blocks of the method 400 are to be included in every case. Further, any number of additional blocks not shown in FIG. 4 can be included within the method 400, depending on the details of the specific implementation.

### Example 1

A computing system is described herein. The computing system can include a processor and a memory. The computing system can also include a memory controller to interface between the processor and the memory. The memory controller is to coalesce requests to access a memory row to form a single request to access the memory row.

The memory can include dynamic random access memory (DRAM) including multiple memory modules. Requests can be reordered to coalesce the requests. Data retrieved during processing of the single request to access the memory row is reordered to satisfy system ordering rules.

### Example 2

A method is described herein. The method includes receiving, in a memory controller, a request to access a memory row. The method also includes determining if a request to access the memory row is present in a memory controller work flow. The method further includes coalescing a received request with the request in the memory controller work flow to form a single request to access the memory row.

The method can further include reordering requests to access the memory row in order to coalesce the requests. The method can also include reordering data from processing the single request to access the memory row to comply with system ordering rules. The work flow can include pipelined memory access requests. Memory can include dynamic random access memory (DRAM) including a plurality of memory modules.

### Example 3

A memory system is described herein. The memory system can include a memory and a memory controller to access the memory. The memory controller can include a work flow and a work flow manager to determine a memory row to which a memory access request refers. The work flow manager can also coalesce the request with a memory access request in the work flow which refers to the memory row to form a single request to access the memory row.

The work flow can include pipelined memory access requests. The memory controller can reorder data from the memory row to comply with system ordering rules. The work flow manager can coalesce memory access requests to decrease memory activation. The memory access requests can be reordered to coalesce the requests. The memory can include dynamic random access memory (DRAM) including a plurality of memory modules.

What is claimed is:

1. A computing system, comprising:
a processor;
a memory; and
a memory controller to interface between the processor and the memory, the memory controller to coalesce requests to access a memory row to form a single request to access the memory row.

2. The computing system of claim 1, wherein the memory comprises dynamic random access memory (DRAM) comprising multiple memory modules.

3. The computing system of claim 1, wherein requests are reordered to coalesce the requests.

4. The computing system of claim 3, wherein data retrieved during processing of the single request to access the memory row is reordered to satisfy system ordering rules.

5. A method, comprising:
receiving, in a memory controller, a request to access a memory row;
determining if a request to access the memory row is present in a memory controller work flow; and
coalescing a received request with the request in the memory controller work flow to form a single request to access the memory row.

6. The method of claim 5, further comprising reordering requests to access the memory row in order to coalesce the requests.

7. The method of claim 5, further comprising reordering data from processing the single request to access the memory row to comply with system ordering rules.

8. The method of claim 5, wherein the work flow comprises pipelined memory access requests.

9. The method of claim 5, wherein memory comprises dynamic random access memory (DRAM) comprising a plurality of memory modules.

10. A memory system, comprising:
a memory; and
a memory controller to access the memory, comprising:
a work flow; and
a work flow manager to determine a memory row to which a memory access request refers and to coalesce the request with a memory access request in the work flow which refers to the memory row to form a single request to access the memory row.

11. The memory system of claim 10, wherein the work flow comprises pipelined memory access requests.

12. The memory system of claim 10, wherein the memory controller reorders data from the memory row to comply with system ordering rules.

13. The memory system of claim 10, wherein the work flow manager coalesces memory access requests to decrease memory activation.

14. The memory system of claim 10, wherein the memory access requests are reordered to coalesce the requests.

15. The memory system of claim 10, wherein the memory comprises dynamic random access memory (DRAM) comprising a plurality of memory modules.
